(19) United States
(12) Patent Application Publication
(10) Pub. No.: US 2008/0090527 A1
(43) Pub. Date: Apr. 17, 2008

(54) Device and Method for Selectively Controlling the Utility of an Integrated Circuit Device

(76) Inventors: Paul Atkinson, San Diego, CA (US); James R. Kruest, San Diego, CA (US); Ronald S. Conero, San Diego, CA (US); Rakesh Kumar, Poway, CA (US); Kendall C. Reyzer, Poway, CA (US)

Correspondence Address: WILLIAM J. KOLEGRAFF;KESTREL WIRELESS, INC., 15050 AVENUE OF SCIENCE, STE. 230, SAN DIEGO, CA, 92128, US

(21) Appl. No.: 11/753,606

(22) Filed: May 25, 2007

Related U.S. Application Data
(63) Continuation of application No. 11/358,352, filed on Feb. 21, 2006.
(60) Provisional application No. 60/803,224, filed on May 25, 2006.
(60) Provisional application No. 60/654,384, filed on Feb. 18, 2005.

(51) Int. Cl. H04B 1/00; H04B 7/00

(52) U.S. Cl. 455/70

(57) ABSTRACT

A radio frequency controller device is provided that enables the utility of an integrated circuit (IC) device using an RF communication. The radio frequency controller device has a switch that is set to a defined state responsive to the RF communication. More particularly, conditional logic circuitry uses the RF communication to determine if the IC's utility should be changed, and sets the state of the switch accordingly. The radio frequency controller device also has an IC interface that allows the IC to determine the state of the switch, and based on the state of the switch, a different utility will be available for the integrated circuit device. The radio frequency controller device also has an antenna for the RF communication, as well as a demodulator/modulator circuit.

### RELATED APPLICATIONS

This application claims priority to U.S. patent application No. 60/803,224, filed May 25, 2006, and entitled, “Device and Method for Selectively Controlling the Utility of an Integrated Circuit Device”; and is a continuation in part to U.S. patent application Ser. No. 11/358,352, filed Feb. 21, 2006, and entitled “Device and Method for Selectively Controlling the Utility of an Integrated Circuit Device”, which claims priority to U.S. provisional patent application 60/654,384, filed Feb. 18, 2005, entitled “A Method and Means of RF Activation of a Target”. This application is related to U.S. patent application Ser. No. 11/296,082 filed Dec. 7, 2005 and entitled “Method and System for Identifying a Target”; to U.S. patent application Ser. No. 11/296,547 filed Dec. 7, 2005 and entitled “Device and Method for Selectively Controlling a Processing Device”; to U.S. patent application Ser. No. 11/296,081 filed Dec. 7, 2005 and entitled “Device and Method for Selectively Controlling the Utility of a Target”; and to U.S. patent application Ser. No. 11/295,867 filed Dec. 7, 2005 and entitled “Device and Method for Selectively Activating a Target”; all of which are incorporated herein by reference.

### FIELD

The present invention relates to an integrated circuit device that is enabled to have its utility controlled using RF (Radio Frequency) communication systems, which may be, for example, an NFC (Near Field Communication), UHF, or HF system. In a particular example, the invention uses radio frequency (RF) devices and processes to set the level of utility available for advanced integrated circuit devices such as processors, MCM's (multi-chip module), or SIPs (system in a package) and the subsystems and finished goods into which they are incorporated. These devices may include, for example, memory, gate arrays, field programmable devices, and programmable logic.

### BACKGROUND

Management of the supply chain is a concern for most manufactures, shippers, and retailers. In order to facilitate efficient check-out of products, manufacturers have place bar code labels on many consumer products. In a similar way, manufacturers and shippers have also labeled pallets of products with bar-code labels to increase shipping efficiency. However, bar code readers require a line-of-site reading, so can not, for example, account for products in the middle of a pallet, or for products buried in a consumer's cart. An RFID (radio frequency identification) system overcomes this problem by labeling a product with an RFID tag. The RFID tag is attached to a product, and when interrogated by an associated RF reader, responds with its identification number. In this way, products can be identified and tracked without the need for line of sight scanning. Unfortunately, RFID has been slow to be adopted, due to the relatively high cost of RFID tags themselves, and to limitations in reading the RFID tags. For example, although RFID tags do not need line-of-sight scanning, the RFID tags must be in a position to receive and transmit low-level RF signals. This not only limits where on a product package an RFID label may be placed, but also causes errors when a product is placed in a position where the label is shielded from the RF reader.

Theft is also serious and growing problem in the distribution of products. In one example, electronic devices, which use an internal microprocessor device, continue to shrink in size while increasing their utility. As these electronic devices become smaller and more capable, they also become easier and more attractive to steal. Devices, such as digital cameras, DVD players, MP3 players, and game devices are popular targets of theft, not only in the retail store by consumers, but also by others in the distribution chain. For example, retail store employees, shippers, warehousers, and even employees of the manufacturer often steal products, and even boxes of products, for their own use or to sell.

In another example, microprocessors and other advanced integrated circuit devices are easy targets for theft. These advanced integrated circuit devices are small, expensive, and are easily sold in a “black” market, or readily incorporated into a thief's system or product. These advanced integrated circuit devices may consist of a single integrated circuit in a package, such as for some microprocessors, microcontrollers, or memory devices, or may have multiple integrated circuits in a single package. In this later construction, often referred to as a multi-chip module (MCM), several integrated circuits cooperate to provide advanced functionality. For example, an MCM may have a processor, modulators, amplifiers, and support circuitry for a complete wireless radio system. This radio MCM may fit in a single package that connects into a target device through pins or a ball-grid array. The advanced integrated circuit may also be constructed for surface mount, and therefore may be provided in a reel of parts for automatic attachment to a target device. Another type of advanced integrated circuit device is the System in a Package, or SIP. An SIP is similar to an MCM in that it has multiple integrated circuit devices in a single package, but the level of integration among the integrated circuits may be higher. As the processors, MCM's and SIP's advance, they have become smaller, making them even easier targets for theft.

It is difficult to implement an anti-theft circuit or scheme with these advanced integrated circuit devices. First, these advanced integrated circuits may be sold boxed separately, and in this state will have no power for activating an anti-theft circuit. Second, it is risky to have a clerk handle a circuit to disable any anti-theft mechanism. These devices are extremely sensitive to ESD (electrostatic discharge), and unless strict anti-static processes are carefully followed, a clerk can easily destroy the device in the handling process. Third, it is often commercially impractical to modify an integrated circuit to incorporate an anti-theft scheme. Some devices, such as advanced microprocessors, take years to design and implement, and would require substantial modifications of masks and processes, as well as additional and costly manufacturing steps. Further, there is limited space and power on these processors, and their designers already compete to add more advanced functionality, and thus would be highly resistant to dedicating scarce space and power to any new anti-theft circuitry. And Fourth, many of these advanced integrated circuits have standard connection geometries, and are already designed into a wide range of products. In this way, an anti-theft circuit could not alter the pin or grid arrangement, and must be implemented within the current package-size limitations. For example, millions of computing devices are sold each year with Intel® processors, and each processor has specific pin or grid connections, as well as an expected package geometry. Any change to the pin or grid arrangement, or any violation of the size restrictions, could cause a substantial redesign effort for Intel's customers. Accordingly, any change to pin or grid arrangements or package sizing would be strongly resisted, even if the theft system would benefit the overall distribution chain.

From the facility where they are manufactured to the retail point-of-sale (POS) where they are sold many high-value electronic devices are vulnerable to theft. Various security techniques are used to minimize the losses (video cameras, security staff, electronic tagging, storing high-value items behind locked cabinets etc). Despite these efforts theft of high-value targets such portable video game players, DVD players, digital cameras, computers, printers, televisions and the like cost manufacturers and retailers billions of dollars per year.

Such rampant theft increase the cost of manufacturing, shipping, and selling of products. Each entity in the distribution chain is at risk for theft, and must take steps to reduce or control the level of theft. This cost is ultimately borne by the legitimate purchaser, which places an unfair “theft tax” on purchased products. Also, since may products are so easily stolen from a retail environment, retailers must take extraordinary steps to secure products. For example, small electronic devices or processing devices are often packaged in oversized holders to make them more difficult to hide. These holders, however, also interfere with a consumers ability to interact with the product, ultimately making the product less attractive to the consumer. In another example, retail stores may place their most valuable and easily stolen products in locked cases. In this way, retail consumers are completely distanced from these products, which reduce theft, but also makes the products difficult to purchase. The consumer cannot read the full labeling on these locked-up products, can not physically interact with them, and must get the attention of a retail clerk, who might have a key, in order to get to the product. In another attempted solution, retail stores put security tags on products, which are intended to be disabled at the check stand upon purchase. If a consumer leaves the store with a live tag, then an alarm sounds. A guard or clerk is expected to stop the consumer and determine if the consumer has shoplifted a product. This process may be dangerous for the guard or clerk, and, since many of the alarms are false, causes undo stress for law-abiding consumers.

None of these attempts to stop retail theft has worked, and all make the retail experience less attractive to the consumer. In this way, the retailer is in the untenable position of having to accommodate and accept a certain (and sometimes significant) level of theft in order to maintain an attractive and desirable retail environment for paying customers. Further, neither the oversized holders, the locked cases, nor the guards address the significant level of theft that occurs between the manufacturer's dock to the retail shelf. Accordingly, the entire distribution chain has resigned itself to an “acceptable” level of theft, and passes the cost of theft on to the legitimate consumer.

The distribution of products faces other challenges. For example, consumers want to choose products that have a particular set of functions or utility, and find it desirable to purchase products matched to their specific needs. Accordingly, manufacturers often manufacture a product in several difference models, with each model having a different set of features. Although this is desirable from the consumer's standpoint, it complicates the manufacturing, shipping, inventorying, shelving, and retailing processes. This problem exists in the configuration of electronic products, computers, and gaming systems for example. Challenges also exist for non-commercial distribution of goods. For example, the military stores, transports, and maintains weapons and gear that is subject to theft and misuse, and this gear often has internal microprocessor or other computing devices. These weapons and gear must be available for rapid deployment and use, but yet must be sufficiently controlled so that they do not fall into enemy hands, or used in ways not approved by military command.

### SUMMARY

Briefly, the present invention provides a radio frequency controller device that enables the utility of an integrated circuit (IC) device using an RF communication. The radio frequency controller device has a switch that is set to a defined state responsive to the RF communication. More particularly, conditional logic circuitry uses the RF communication to determine if the IC's utility should be changed, and sets the state of the switch accordingly. The radio frequency controller device also has an IC interface that allows the IC to determine the state of the switch, and based on the state of the switch, a different utility will be available for the integrated circuit device. The radio frequency controller device also has an antenna for the RF communication, as well as a demodulator/modulator circuit.

In one arrangement, the radio frequency controller is connected to the IC device, but is physically outside the IC's packaging. For example the radio frequency controller may change the state of a pin on the IC, thereby changing the function or operability of the IC device. In another example, the radio frequency controller is inside the IC device's packaging, and able to more intimately affect IC circuitry. The radio frequency controller may be mounted inside the packaging and coupled to the IC circuitry, or may be integrated within the IC circuitry itself. In some cases, the IC device may be constructed as a system in a package, or incorporated into a multi-chip Module (MCM).

Advantageously, the disclosed radio frequency controller device enables an RF device to selectively change the utility of an IC device, and by association, a device incorporating the IC device. The radio frequency controller device functionality may be readily incorporated or adapted to many configurations, so enables alternative manufacturing process, flexible distribution accounting, and a denial-of-benefit security system.

### BRIEF DESCRIPTION OF THE DRAWINGS

FIG. 1 is a block diagram of a radio frequency activation device with controlled utility.

FIG. 2 is a block diagram of a Logic Gate RFA Switch.

FIG. 3 is a block diagram of a Power Pin RFA Switch.

FIG. 4 is a block diagram of a Passive Pull Down RFA switch.

FIG. 5 is a block diagram of a Direct Integration of Secure Digital Activation.

FIG. 6 is a block diagram of a RFA function integrated into the product die.

FIG. 7 is an illustration of an RFA IC incorporated in the product package (“SiP”).

FIG. 8 is an illustration of a RFA IC attached outside the product IC package.

FIG. 9 is a picture of RFA IC on a generic PCB and a PC DIMM.

### DETAILED DESCRIPTION

Introduction

Radio Frequency Activation, or RFA, is a system that includes devices and processes for selectively activating electronic or integrated circuit devices. The RFA system has been fully described in co-pending U.S. patent application Ser. No. 11/358,352, filed Feb. 21, 2006, and entitled “Device and Method for Selectively Controlling the Utility of an Integrated Circuit Device”, which is incorporated herein in its entirety. Although this discussion teaches specific implementations and circuits, it will be understood that these are only exemplary of the RFA system, processes, and devices.

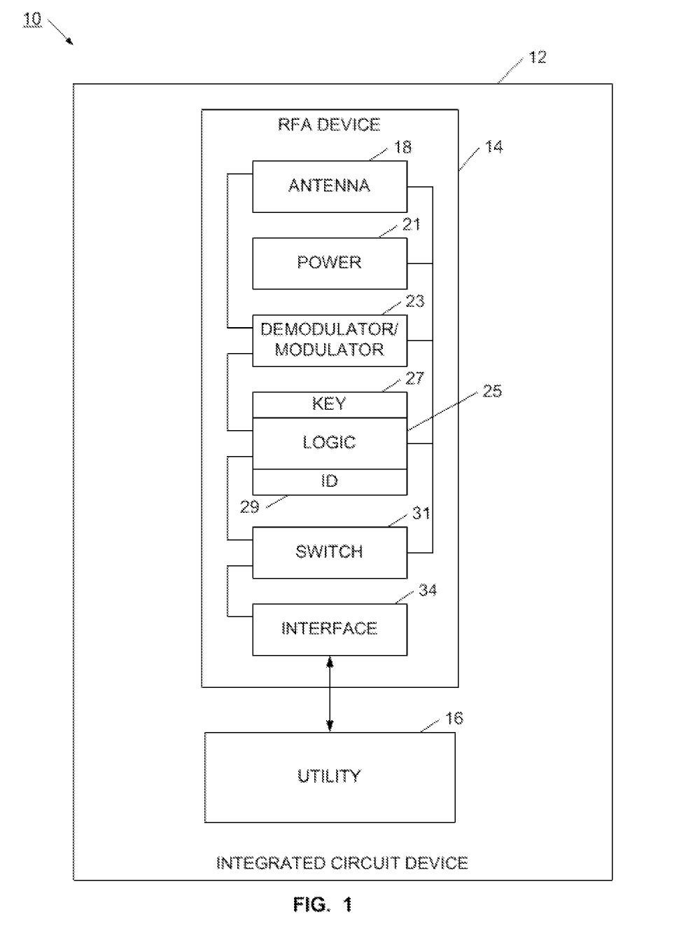

Referring now to FIG. 1, an integrated circuit device 10 is illustrated. IC device 10 includes a radio frequency activation (RFA) device 14 within the housing 12 of the IC device. The RFA device is used for controlling the utility of the IC device 10. To facilitate ease of manufacture, the RFA device 14 is provided in a package convenient for large-scale production. For example, the RFA device may be in the form of an integrated circuit package, or in the form of a surface mount device. Either way, the RFA device may be easily designed into or onto the IC device. In this way, the RFA device may be included with an IC device in a cost effective manner, and may be flexibly configured according to application requirements. It will be appreciated that the RFA device may be provided in other manufacture-friendly forms.

IC device 10 may be incorporated into an electronic device such as a computer, TV, appliance, MP3 player, camera, game counsel, or toy. In another example, IC device may be sold as a discreet component or part, or as part of a microprocessor system or package. During manufacture or preparation of the IC device 10, the RFA device 14 has been incorporated into the IC device in a way that allows the RFA device 14 to control the utility of the IC device. For example, the RFA device 14 has a switch 31 that couples to some utility 16 of the IC device. The switch is coupled to the utility 16 through the IC device interface, which may be a logic line, a power line, a control line, a multi-line interface, or a memory location. Also, it will be appreciated that the IC device interface may be selected according to the physical form of the RFA device. For example, if the RFA device is in a surface mount form, the target interface will include a pad contact to the printed circuit board or other substrate.

The switch 31 is set by the RFA device according to received data, and is used to control the utility available for the IC device or for use of the IC device. More particularly, the switch 31 has multiple states, with each state being associated with an available state of utility for the IC device. In a specific application, the switch may be switched between two available states of utility. In operation, the RFA device acts as an interface between two distinct systems. First, the RFA device has a low-power RF circuit that is configured to receive data from a low-power RF source, and using power received from the RF source, determine if the IC device is authorized to have its utility changed. If so, the RFA device, using its low-power circuit, sets the switch to the authorized state. The second system is the full power circuit of the IC device or its associated electronic device. This full power target utility circuit may include, for example, other microprocessors, power supplies, memory systems, and other electric and electronic components. The IC device utility circuit couples to the switch in a way that allows the IC device utility circuit to act according to the state of the switch. For example, each time the IC device is activated, the IC device utility circuit tests the state of the switch, and depending of the switch's state, presents a particular level of utility. Stated more succinctly: the state of the switch is set using a low power circuit, which sets the utility available to the full power circuit. In a typical case, the RFA device will also be powered from the full power circuit. In other cases, the RFA device may remain passive when the IC device is operating.

When the IC device 10 enters the distribution chain, the IC device 10 is set to have one utility. For example, this utility could be a severely comprised utility, where the IC device or its associated electronic device has no useful function available. In another example, the utility may be set to a demonstration utility that allows limited demonstration functionality. It will be appreciated that the available utility may be set according the requirements of the specific distribution chain. At some point in the distribution chain, for example, when the IC device is transferred to a consumer, it may be desirable to change the available utility. Accordingly, when the IC device is in the presence of a reader or scanner at a point-of-sale, the reader is able to read an identifier value or other identification from the IC device. The reader uses the identifier to generate or retrieve an authorization key. Provided the point-of-sale device has authorization to change the utility of the IC device, the reader transmits the authorization key to the RFA device 14. In one example, the reader reads the ID 29 from the RFA device 14, and transmits the authorization key to the RFA device 14 using an RF (radio frequency) communication, such as in the UHF or HF bands. It will be appreciated that other types of wireless communication may be used. For example, the communication may use infrared (IR) communication in one or both directions. In another example, the IC device may make physical contact with the reader for effecting the communications.

The RFA device 14 uses the received authorization key to set the switch 31 to another state. Then, when the consumer tries to use the IC device 10 in its full-power state, the IC device utility 16 is able to function according to the new state set in switch 31. In this switch state, the IC device has a different utility than when the switch was in the first state, which is typically a fully-functioning state. The RFA device 14 has logic 25 coupled to the switch 31 that uses the authorization key to effect a change the switch 31. In one example, the RFA device 14 has a restricted access key 27 that was defined and stored with the RFA device 14 during the manufacturing process for the target 10. This restricted access key may not be externally read, altered, or destroyed, but may be read or otherwise used by the RFA logic 25. This restricted access key 27 may be compared or otherwise used with the received authorization key to determine if the RFA device 14 is enabled to change states of the switch 31.

In a specific example of product using the IC device 10, the product is an MP3 player. During manufacture of the MP3 target device, an RFA device is installed with the IC device of the MP3 player. The RFA device may be, for example, an RFA integrated circuit DIP device, a surface mount device, or other circuit module. In the case where the RFA device is a surface mount device, the RFA device may be applied to a circuit board of the player in a way that the RFA switch 31 is able to control a utility function 16 of the IC device, which affects the playability of the MP3 product. For example, the RFA device may connect to the power source of the player's operational circuitry so that the player will not function until the switch is changed. In another example, the RFA device couples to the decoder processor in the player, and restricts the ability of the player to properly play music files until the switch is in a proper position. The player may also have a limited demonstration interface until the full user interface is enabled by changing the switch. A restricted access key is also stored in the RFA device, and the switch 31 is set to a state so that the MP3 player's utility is compromised.

The MP3 player is thereby manufactured and ready for sale as a compromised MP3 player that will not properly power-on or function. In this way, the compromised MP3 player would be nearly useless to a consumer, and therefore would be less likely to be a target of theft. The manufacturer has also stored an accessible identification 29 in the RFA device. In some cases, the identification may be pre-stored in the RFA device, and in others, the manufacturer will assign the ID during the manufacturing process. For example, the accessible identifier may be a stored value that is accessible through, for example, an RFID reader system. The compromised MP3 player may be shipped through the distribution chain and to the retailer with a substantially reduced threat of theft. Also, the retailer may display and make the MP3 player available for customer handling in a retail environment with reduce risk of theft. In this way, reduced security measures may be taken at the retail level, such as using locked cases or sophisticated packaging, since the consumer would obtain no benefit by stealing a nonworking, compromised MP3 player.

When a consumer decides to purchase the MP3 player, the consumer may take the MP3 player to the point-of-sale terminal and have it passed proximally to an activation device, such as a reader or a scanner. As the MP3 player is close to the activation device, its accessible ID 29 is read by the activation device by retrieving the stored accessible ID using a wireless or EM (electromagnetic) communication, for example a point-of-sale (POS) or mobile device operating in the HF or UHF frequency bands. For example, the communication may be an RF (radio frequency) communication. The communication from the point-of-sale device to the RFA device 14 is though antenna 18. In one arrangement, antenna 18 is able to both receive and transmit data to the point of sale terminal. The point-of-sale terminal may have a network connection to an operation center, and sends the accessible ID value to the operation center. The operation center, which has a database of RFA device identifications associated with their restricted access keys, retrieves the particular authorization key for the RFA device in the MP3 player that is at the point-of-sale device. At the point-of-sale terminal, additional confirmation actions may be taking place. For example, a clerk may be accepting payment from the consumer, or may be checking a consumer's identification or age. These other confirmation criteria may then be used to confirm that the point-of-sale terminal is ready to restore the utility of the IC device and its associated MP3 player. Provided the activation device determines restoration is appropriate, the activation device transmits the authorization key to the RFA device using a wireless communication. The RFA device 14 receives the authorization key, and using its logic 25, compares the authorization key to its pre-stored restricted access key 27. If the keys match, then the RFA device 14 uses its low-power source to change the state of the switch 31. In the new state, the IC device utility 16 is fully available, and allows the player to fully function for the consumer.

In another example, the consumer purchases the MP3 player from an online retailer, and the MP3 player is shipped or mailed to the consumer. In this scenario, several alternatives exist as to where the utility for the MP3 player may be restored. In one alternative, the online retailer has an activation device in their warehouse or shipping department, and a retail employee restores the utility to the MP3 player as part of the shipping process. In another alternative, the MP3 player is shipped with compromised utility, and the shipper has an activation device that they use to restore utility prior or at the time of delivery. In this alternative, the driver of the delivery truck may restore utility as the consumer accepts the MP3 player, thereby removing risk of theft during the entire shipping process. In a final alternative, the consumer has a home activation device, and the consumer uses the activation device to restore utility to the MP3 player. In this last alternative, the MP3 player is in a compromised utility from the manufacturer all the way to the consumer's location, and it is the consumer, after the commercial transaction is complete, that finally restores utility to the MP3 player.

In some cases, the RFA device may have additional circuitry for confirming that the utility of the IC device has been restored. For example, the state of the switch may be measured, or another test or measurement may be taken. According to whether or not the switch was set successful, a different value may be placed in a confirmation memory. The confirmation memory may be read by an activation device to confirm to the consumer and to the network operations center that activation was successful. By confirming successful activation, the retailer may have a higher degree of confidence of consumer satisfaction, and may accurately and timely report and authorize payment to the supplier of the MP3 player.

RFA device 14 is constructed to receive an authorization key via a demodulator/modulator 23. Demodulator/modulator 23 may be a wireless communication circuit, such as a radio frequency or electromagnetic receiver. The RFA device 14 has logic 25 which is configured to receive the authorization code and make a determination if the switch 31 should have its state changed. The logic 25 may include logic structures as well as dynamic or non-volatile memory. In one example, logic 25 uses a target key 27 in making the determination of whether or not the switch can change to another state. In one example, target key 27 has been stored during the manufacturing process in a manner that is not readable using external devices. For example, target key 27 may be placed in a nonvolatile, non erasable and non alterable memory of the RFA device during manufacture. This target key may be the same value as the authorization key, so the logic simply performs a comparison between the restricted access target key 27 and the received authorization key to determine if the switch 31 of the RF device may be changed. It will be understood that other logical processes may be used in making this determination. Provided the logic 25 determines the switch 31 may be changed, the logic causes the switch 31 to change states. In one example, the switch 31 is a change effecting device. The change effecting device may be, for example, an electronic switch, an electrical switch, a fuse, a conditional break in a trace, a logical state, or may be a set of values defined in a memory location. In another example, the change effecting device is an electrically switchable optical material such as electrochromic material. It will be appreciated that other devices may be used for the change effecting device.

The change effecting device may change state upon the application of an activation power, or may use logical process to set or change values stored in memory. The activation power 21 may be, for example, a separate battery which powers the logic 25, the demodulator/modulator 23, and the switch 31. In another example, the activation power 21 may be a converter for converting a received radio frequency or electromagnetic energy into available power. Also, the activation power may be wholly or partially obtained from a source external to the target. It will be appreciated that other electronic components may be necessary to implement such a converter. In another example, activation power may be provided by the operational power for the full device. For example, if the full device is an MP3 player, and the MP3 player has an operational rechargeable battery, the rechargeable battery may have sufficient initial charge to power the RFA device while the target is in the distribution chain. In yet another example, activation power may be provided by multiple power sources. For example, a small battery may power the change effecting device, while an RF or EM converter device may power the logic and communication circuit. It will be appreciated that many options and alternatives exist for powering the circuitry within the RFA device 14.

RFA device 14 may have a confirmation circuit or memory with logic 25 which changes state according to the actual or probable state of the switch 31. In some cases, the actual state of the switch may be detected, or the actual state of the switch may be measured. In other cases, the actual states may not be conveniently measured or detected, so some aspect of the change process may be measured or detected instead. In this case, a confirmation that change process was being successfully performed leads to a high probability that the utility of the target was also successfully changed. Accordingly, the confirmation logic may directly detect the state of the switch 31, or may have measured the electrical processes used in making the change. For example, the current passing through a fuse may be measured, and thereby confirm that a sufficient amount of electricity has passed through the fuse to cause it to break. Although not a direct detection of the state of the switch, it is highly probable that the state of the fuse has changed, resulting in a change of state in the switch. In another example, logic 25, and may confirm that logical processes were properly performed for setting the switch. In another example, logic 25 may directly connect to the utility means 16 itself, to confirm that the switch changed. Once logic 25 receives confirmation that the switch changed, that confirmation signal may be communicated to an activator device using a transmitter, or may be read responsive to a request from the activator. The RFA device 14 may therefore provide feedback to the activation and distribution control system to confirm that utility has been changed. This information may then be used to generate reports or to initiate payment to parties within the distribution chain.

RFA-enabled products incorporate an RFA circuit, a product-specific switch, and an antenna, which is sometimes removable. The switch is embedded in the IC or product, and is initially set at the factory in a manner that renders it inoperable, that is, it “deactivates” the product by deactivating the devices processor or other operational IC. Alternatively, the utility of the product may be reduced or limited, for example, allowing the product only to operate in a limited demonstration mode. At a certain point in the distribution chain, which is normally the point-of-sale (“POS”), the product is re-enabled or “activated” using radio frequency identification (RFID) or near field communications (NFC) systems. In the disabled state the product or device has insufficient utility or economic value (it doesn't work properly) to attract thieves. This proven approach to theft prevention is known as denial-of-benefit security.

Radio Frequency Activation (RFA) is accomplished through a secure network transaction with an RFA-enabled RFID circuit, for example, using an UHF, HF or NFC enabled device. The basic functions of an RFA-enabled device include:
conditional logic for the RFA transaction set;
incremental protection for memory within the device;
power and data outputs to effect a switching mechanism (which enables or disables the product or device); and
communications protocols and IC-specific data;

RFA functions may also be incorporated directly into a variety of different types of semiconductor products. The benefit of this approach is that not only is the device itself protected, but also the circuit board onto which it is assembled, and the final product. This creates further opportunities for semiconductor device manufacturers to differentiate their products from their competitors in addition to reducing losses due to theft.

There are two general approaches to implementing RFA for an IC device: those approaches that do not require modifying existing semiconductor integrated circuits, and those that do. It will be understood that other approaches may be used. The former starts with a discussion of control methodologies that work with existing devices and related assembly and packaging concepts. These solutions are particularly suited for transitioning RFA into existing product lines where changes to circuit boards are infrequent (e.g. long life cycles).

Alternately, certain classes of semiconductor devices, particularly those of high value, can realize additional security and economic benefit by modifying the devices to directly incorporate RFA functionality. This can be an attractive, albeit longer term option. The discussions continue with methods of Secure Digital Activation, where products such as microprocessors and microcontrollers can take advantage of serial data streams to effect activation. As noted above, the benefits include cost effective security of the device, the circuit board it's mounted on, and the final consumer, industrial or military product.

Control Methodologies

The RFA switch is used to control the operation or accessibility of the IC, product or device. In this section, some of the generic approaches to controlling the device with the switch will be presented. Various circuits are considered that generally have one or more pins that can be accessed by the switch to control the device. Examples of these Pins are:
a reset pin;
a power on reset pin;
a good power pin;
a chip select or chip enable pin;
one or more power pins; or
combinations of these pins.

A reset pin is typically an active low input. When held low, the IC device is put into an initialized state and does not resume normal operation until the reset is returned to a high logic level. At the factory, the switch is configured to connect to the reset pin of the device and hold it in a low logic state. If the device or its IC device were powered up, the IC device would remain in the reset condition and would not operate. After the RFA chip is activated at the POS, the signal transmitted to the device enables the reset pin and restores functionality to the device.

A good-power pin looks for an external signal telling the device that the power supply has reached a stable state. By holding this pin low, the IC device will be disabled while it is waiting for the good power signal to reach a high logic state. After activation, the RFA chip will enable the good power pin and return control of the pin to the external system.

A chip-select pin typically looks for a low logic state to enable the device. The RFA chip will hold a high logic signal and prevent the device from being accessed. After activation, the RFA chip will enable the chip select pin and return control to the external system.

For devices that do not have one of these logic level pins, the RFA chip will control the power to the device by placing a switch in series with one of the power supply lines.

There are two desirable requirements for the switch. The first requirement is that the switch does not interfere with the normal assembly and test sequence of the device. The second is that the switch, after activation, be transparent to the user of the device during normal operation. Ideally, the switch would be electrically “removed” from the circuit after activation. In most cases digital logic signals will satisfy these requirements and are appropriate control signals. For semiconductor processes that support it, a fuse element provides further refinement.

Assembly and Test Considerations

Typically, every IC device or assembly undergoes testing in its final packaged configuration. When RFA is incorporated it is desirable that the testing is not impeded in any way, therefore the RFA chip is initially set in its Active state. Once the final testing is completed, the chip is “Loaded” with the RFA data and keys and put into a disabled, non-operative state for distribution.

Logic Approaches

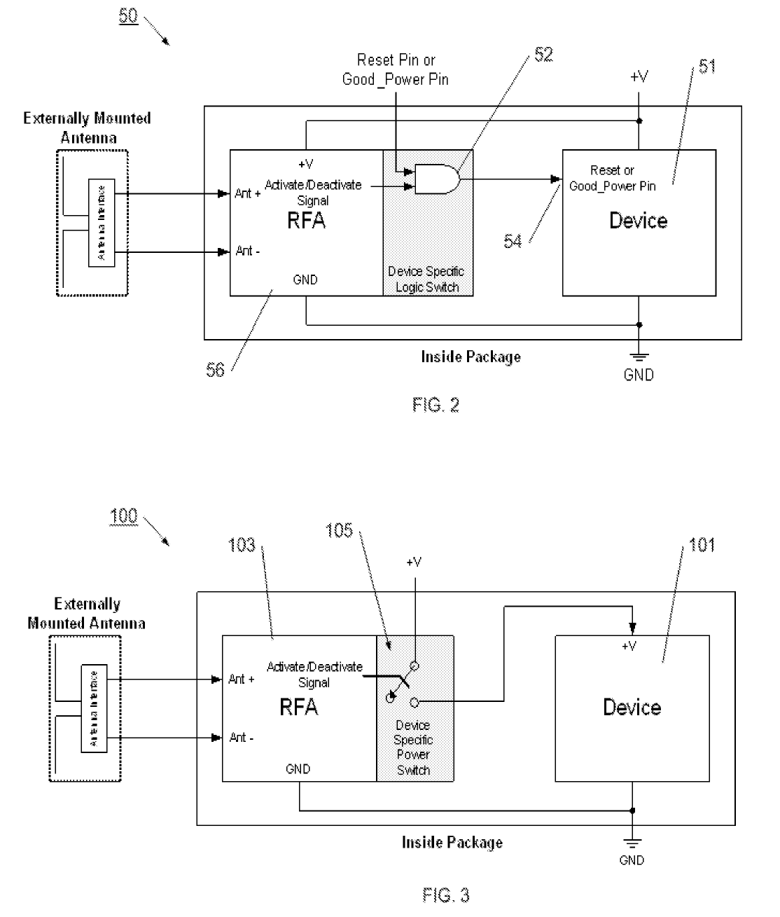

An IC system 50 is illustrated in FIG. 2. Some devices 51 will use the simplest concept for the switch, a logic gate, as shown. In this implementation, the logic gate 52 is used to control the access to the device's reset or good power pin 54. Depending on the control logic needed, both AND gates and OR gates are available. The device 51 is assembled so that the reset or good power pin is gated through the RFA chip 56. Initially the default state of the Activate/Deactivate signal is set so that the external pin controls the state of the reset pin or good power pin, allowing for normal testing of the part. After testing, the process of loading the RFA chip with the key or other data places the product into the deactivated state by causing the Activate/Deactivate signal in the RFA chip 56 to go to logic low, over-riding the external control and forcing the device into a reset condition. Later, upon activation at the POS, the Activate/Deactivate signal is set to logic high, returning control to the external pins.

Power Pin Approaches

An IC system 100 is illustrated in FIG. 3. For devices 101 that do not have an accessible logic control pin, such as a reset or good power pin, the RFA chip 103 controls the application of power to a portion of the device. A power field effect transistor (FET) switch 105 within the RFA chip 103 may be used to turn on or off the power to the I/O area of the device 101. It will be appreciated that other switches or switching devices may be used. The FET switch 105 is designed to have low ON-resistance and to support the necessary current levels.

As before, the device is assembled with the switch in the closed state and the device is powered for final testing. Subsequent Loading of the key or other data places the switch in the opened state and power is prevented from reaching the device. It is now in the deactivated state and can no longer be powered up externally. Later, upon activation, the RFA chip again closes the switch and the device is operational.

Passive Approaches

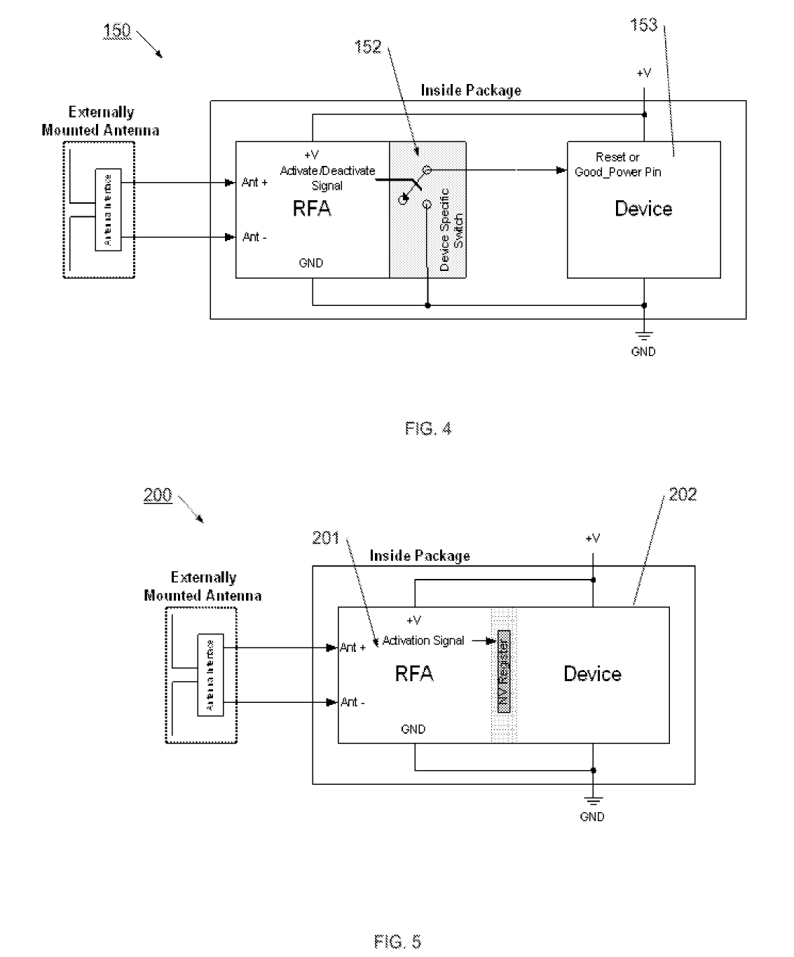

An IC system 150 is illustrated in FIG. 4. The FET switch 152 could also be used in passive pull-down configurations for controlling logic pins, as shown in FIG. 4. The state of the switch 152 determines whether or not the device 153 is operable. After assembly, the switch 152 is open and the reset or good power pin can be controlled externally. Upon deactivation, the switch is closed and the device is in a permanent reset state independent of the external reset pin. At the POS and upon activation, the switch is opened leaving the reset pin free to be accessed as it normally would in its circuit application.

FET switches are not the only devices suitable for passive control. Specialized semiconductor processes may also take advantage of unique or proprietary devices in implementing control switches, such as SCRs, fuses and anti-fuses.

Secure Digital Activation (SDA)

The previous approaches allow for straight-forward means of controlling the operation of nearly any integrated circuit device. More sophisticated devices such as micro-processors and micro-controllers can utilize additional capabilities of the RFA chip for added security. With these devices, a unique multiple bit code known only to the device is loaded into the RFA chip memory. Once deactivated, this code is only accessible to the device after a successful POS transaction and activation. The code is clocked out of the serial pin of the RFA chip by the device, where it is compared to the expected code. If the code matches correctly, the device will operate normally. Otherwise the device will not operate, and may generate an informational message.

Direct Integration of RFA

An integrated RFA/IC system 200 is illustrated in FIG. 5. In the previous discussions the RFA chip was integrated with existing devices by incorporating the RFA chip as an add-on circuit either in the IC package or mounted on the IC package. Various other packaging implementations may be used. While this provides an efficient path to realizing the benefits of RFA, another approach is to integrate the RFA functionality 201 directly into the IC device 202 itself. In this manner, the device 202 is intimately in communication with the RFA circuitry and more sophisticated means of control can be implemented. This lends itself particularly well to micro-processors and micro-controllers which can recognize an activation signal as a multiple bit “code” to permit operation. This is illustrated in FIG. 5. The RFA circuitry is incorporated into the device package itself, providing the security of RFA while minimizing the impact to existing system level products.

Microprocessors

The microprocessor segment of the market is ideally suited for RFA product activation. Multiple approaches may be taken to deactivate the microprocessor device. Most manufacturers utilize a reset pin and a good power pin on their devices. The following list shows the major microprocessor families from Intel® and AMD® and the corresponding pins that would be suitable for utility control.

Intel®—Itanium® 2, Xeon®, Pentium®

PWRGOOD pin

Assert low to indicate non-stable power, device will not start up until low-high transition indicates power is stable.

RESET# Pin

Assert low to reset device, limited to 10 ms duration if not in conjunction with PWRGOOD pin.

AMD®—Opteron®, Turion®, Athlon®

PWROK Pin

Assert low to indicate non-stable power, device will not start-up until low-high transition indicates power is stable

RESET_L Pin

Assert low to reset device, works in conjunction with PWROK on start-up.

As discussed earlier, a microprocessor is ideal for using the SDA code. This approach would improve security and eliminate the need for the RFA switch to share the reset or good power pins.

Microcontrollers

There are large numbers of microcontroller families from numerous manufacturers such as Texas Instruments®, Philips®, ST Micro®, Fujitsu® and others. Typical microcontrollers, ranging from 8 bit through 32-bit ARM-based devices, have reset pins or equivalent. Protection of these devices is accomplished through control of reset, power-on reset or init pins as discussed above. As with microprocessors, microcontrollers may also use SDA techniques to implement additional security.

Field Programmable Gate Arrays

The major FPGA manufacturers provide many devices with varying levels of complexity. Correspondingly, there is a wide variation in the availability of pins for applying the RFA methodology. Following are a representative summary of device offerings from Altera®, Xilinx®, and Lattice®.

Altera®—Stratix® II, Cyclone®, MAXII™

Xilinx®—Virtex®, Spartan®, CoolRunner®

Altera® and Xilinx® FPGAs have no external reset pins, instead relying on internal power-on reset capability. RFA is implemented in these devices by controlling the power connection to the VCCIO pins. The current requirements for supplying the Input/Output section of the devices are modest, typically less than 5 mA, and easily met with the FET switch within the RFA chip. In the deactivated state the interruption of the power to the I/O area causes the device to remain in the reset, non-operating state. After activation, power is again routed to the I/O area and the device can rise out of the reset state.

Lattice®—SC, XP, ECP2

RFA can be incorporated into these families of FPGAs from Lattice® in a variety of ways. Each device utilizes a global reset pin that can be controlled using the logic approach previously discussed. Alternatively, the VCCIO is separate from the main power supply and the modest current requirement for the I/O area allows for controlling the VCCIO power supply using the FET switch method.

Memory Chip Products

There are many Flash and other non-volatile memory products available in the market from many vendors with many configurations. Most of these devices have one or more logic control pins such as chip enable or reset which can be used in implementing the logic method already described. The chip-enable pin controls access to all or portions of the memory. When deactivated, the switch will hold these pins at the appropriate logic state to prevent or limit the operation of the part until the product is activated at the POS.

Memory Card Products

PC Memory Modules

The personal computer market uses memory products in the form of SIMMs, DIMMs, and SO DIMMs. These consist of multiple memory chips assembled onto a printed circuit board. An RFA chip integrated into the board level product uses the logic method previously described to control the chip select line associated with the module.

Alternatively one or more of the individual memory chips on the module may incorporate its own RFA chip. This further improves security and minimizes tampering of the product.

Memory Cards

Memory cards cover a broad range of devices used in digital cameras, portable music players, and in portable flash drives for personal computers. Some of these devices are:

Secure Digital [“SD”] memory card

Compact Flash [“CF”] memory card

XD-Picture Cards [“XD”]

USB Flash Drives

In general, these devices are enclosed in a plastic case thus hiding the devices and the circuit boards that are used. Depending on the specific device, logic or power control methods may be used in implementing the RFA functionality.

For SD memory cards that employ Content Protection of Recordable Media (“CPRM”), or for memory cards with similar authentication procedures, the SDA method may be used for added security.

Microdrives

Miniature hard drives, or microdrives, are often used in MP3 players and PDAs. The RFA switch is used to control the power to these devices.

RFA Implementation Approaches

RFA can be implemented in several ways. A separate RFA circuit can be incorporated either inside or outside the IC Product package, or can be mounted on a PCB as a standalone chip. With new product designs, the RFA “core” can be directly integrated into the device itself. These instances are illustrated below.

In the simplest form, the RFA IC chip or circuit requires 4 connections: Antenna (+), Switch, Power and a common Ground/Antenna (−). A Clock may also be needed if the SDA method is used. The RFA chip receives its power in one of two ways, through the Antenna connections, or through the Power connection. When the device with which it is associated is not powered, the RFA chip works similar to a passive RFID chip, receiving both its power and communication through its antenna from the reader's RF field. This occurs during Loading of the code or key data during manufacturing, and later at the POS for activation. The antenna for the RFA chip is positioned to facilitate interfacing with the RF reader, and may take various forms as needed by specific products. In most cases the RF “front end” functions take place at the antenna element, where the components needed for power rectification and signal demodulation are placed. This is especially important when the RFA circuitry is integrated directly into the target product, removing the need for the target device to deal with RF design considerations.

After activation, and when the device is placed into service and powered up, the RFA chip (or RFA circuitry if directly integrated) is powered by the device's power supply through its Power input. While powered in this manner, the RFA chip becomes active and the switch signals assume values expected by the device. A simple diode isolation circuit assures that the RFA chip is capable to be powered by either the antenna or the device power without either interfering with the other.

Integrated into the Product IC Chip

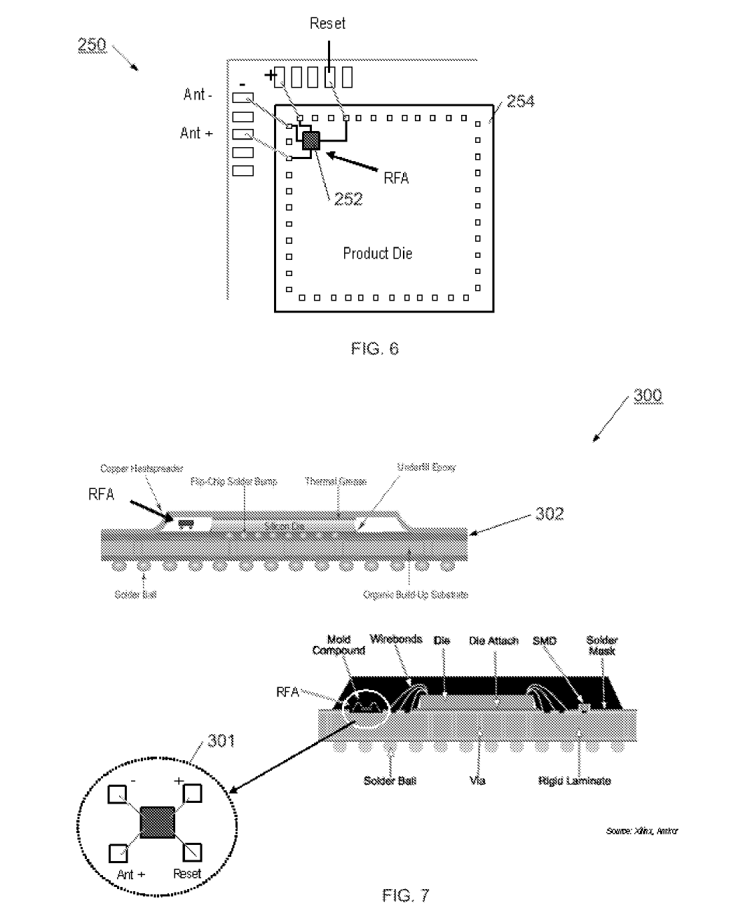

In this approach 250 the RFA circuitry 252 is made available to the manufacturer as an IP core and designed into the product silicon, such as a microprocessor 254 or microcontroller. FIG. 6 shows an illustration of the RFA circuit 252 occupying a small area of the product chip 254. The antenna, power, ground and control pads for the RFA section may be dedicated or shared. Sharing pins is possible provided that the device circuitry presents a high impedance state when not powered. The Antenna (+) may require an additional pad on the die if the nature of the device and process permit bringing the RF signal onto the chip. Otherwise, performing the power rectification and demodulation at the antenna element may allow sharing the antenna input with another high impedance or low frequency package pin. This external antenna may be fabricated in the form of a flex circuit, attached to the corresponding pins on the package, and later removed after activation.

Inside the Product Package [“SiP”]

The use of Multi-Chip packaging 300 or “SiP” (system in package) has become common in the semiconductor industry, as illustrated in FIG. 7. Using SiP techniques an RFA circuit or IC 301 can be incorporated into the packaging 302 of existing devices, thereby achieving the benefits of RFA efficiently. FIG. 7 shows two of the possible instantiations of this approach. In some cases this approach may require modifications to the product package to accommodate the RFA chip and its connections. The RFA chip is assembled as a flip-chip or by using conventional die attach to the package substrate and wire bonds to the appropriate pins.

Outside the Package [“PoP”]

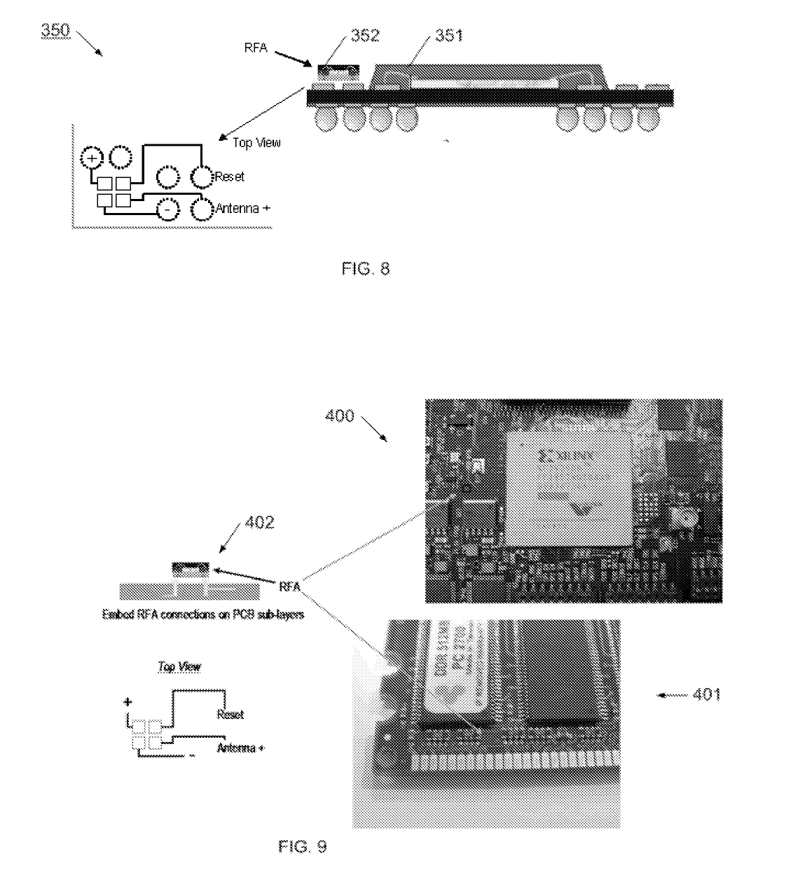

A PoP system 350 is illustrated in FIG. 8. Another packaging approach is to mount the RFA chip 352 (either in die form or as a packaged part) on the outside of the product package 351. For certain package types, such as PBGAs, a package design to accommodate a surface mount version of the RFA chip is a straightforward approach. Layout changes to the laminate substrate provide the solder pads for attaching a surface mount RFA part. A lead-less package such as a QFN is preferred since it is less prone to tampering. The use of conformal coating over the RFA chip provides additional security.

As before, the antenna may be connected directly to dedicated RFA chip pads, or shared with other device pads as applicable. FIG. 8 shows a simplified version of such an implementation.

On the PCB

Similar in approach to PoP, an RFA IC may be directly assembled onto a printed circuit board. Some examples are discussed here.

The manufacturer of products using printed circuit boards can incorporate an RFA chip into the design of the board. The switch is used to enable or disable a suitable signal which affects the utility of the product. Buried traces, leadless packages and epoxy potting techniques further extend the security and reduce vulnerability to tampering. FIG. 9 has a photograph of a PCB 400 and a DIMM 401, each having an integrated RFA circuit 402 or IC. Suitably, an SDA method would provides even greater protection.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed, is:

1. An wirelessly controlled integrated circuit device, comprising:
an integrated circuit device;
a wireless communication device, comprising:
a switch coupled to operating circuitry in the integrated circuit device;
a circuit constructed to set the state of the switch responsive to a received wireless signal;
a power source coupled to the circuit; and
wherein the state of the switch selectably sets the utility of the operational circuitry for the integrated circuit device.

2. The wirelessly controlled integrated circuit device according to claim 1, wherein the wireless communication device is a Radio Frequency (RF) device.

3. The wirelessly controlled integrated circuit device according to claim 1, wherein the wireless communication device is a Near Field Communication (NFC) device.

4. The wirelessly controlled integrated circuit device according to claim 1, wherein the switch couples to a logic line for the operational circuitry.

5. The wirelessly controlled integrated circuit device according to claim 4, wherein the switch includes a field effect transistor to set the state of the logic line for the operational circuitry.

6. The wirelessly controlled integrated circuit device according to claim 1, wherein the switch couples to a power line for the operational circuitry.

7. The wirelessly controlled integrated circuit device according to claim 6, wherein the switch includes a power switch.

8. The wirelessly controlled integrated circuit device according to claim 6, wherein the switch includes a field effect transistor to control power to the operational circuitry.

9. The wirelessly controlled integrated circuit device according to claim 1, wherein the switch connects to a signal line of the integrated circuit device.

10. The wirelessly controlled integrated circuit device according to claim 9, wherein the signal line is a reset line, a power-on line, a good-power line, a chip-select line, a chip-enable line, or a plurality of power lines.

11. The wirelessly controlled integrated circuit device according to claim 9, wherein the signal line is two or more selected from the group consisting of: a reset line, a power-on line, a good-power line, a chip-select line, a chip-enable line, and a plurality of power lines.

12. The wirelessly controlled integrated circuit device according to claim 1, wherein the integrated circuit device and the wireless device are in a same package enclosure.

13. The wirelessly controlled integrated circuit device according to claim 12, wherein the package enclosure has pinouts, and an unassigned pin is coupled to the wireless device as part of an antenna structure for the wireless device.

14. The wirelessly controlled integrated circuit device according to claim 1, wherein the circuitry further comprises:
an antenna;
a modulator/demodulator; and
conditional circuitry.

15. The wirelessly controlled integrated circuit device according to claim 14, wherein the antenna is removable.

16. The wirelessly controlled integrated circuit device according to claim 14, wherein the conditional circuitry is a logic circuit, a processor, a microprocessor, a microcontroller, or a comparison circuit.

17. The wirelessly controlled integrated circuit device according to claim 1, wherein the power source is a modulator/demodulator or a battery.

18. The wirelessly controlled integrated circuit device according to claim 1, wherein the operating circuitry operates at compromised utility responsive to a first state of the switch, and operates at a full operational utility responsive to a second state of the switch.

19. The wirelessly controlled integrated circuit device according to claim 1, further including an isolation switch between the low power circuit and the operating circuitry.

20. The wirelessly controlled integrated circuit device according to claim 1, wherein the integrated circuit is selected from the group consisting of: microprocessor, microcontroller, field programmable gate array, memory chip, and memory card.

21. The wirelessly controlled integrated circuit device according to claim 20, wherein the microprocessor is selected from the group consisting of: Intel Itanium 2, Intel Xeon, Intel Pentium, AMD Opteron, AMD Turion, and AMD Athlon.

22. The wirelessly controlled integrated circuit device according to claim 20, wherein the field programmable gate array is selected from the group consisting of: Altera Stratix II, Altera Cyclone, Altera MaxII, Silinx Virtex, Xilinx Spartan, Xilinx CoolRunner, Lattice SC, Lattice XP, and Lattice ECP2.

23. The wirelessly controlled integrated circuit device according to claim 20, wherein the memory card is selected from the group consisting of: PC memory module, SD card, CF card, XD card, USB flash drive, and microdrive.

24. The wirelessly controlled integrated circuit device according to claim 1, wherein the switch further comprises a change effecting device.

25. The wirelessly controlled integrated circuit device according to claim 24, wherein the change effecting device is an electrically switchable optical material.

26. The wirelessly controlled integrated circuit device according to claim 1, wherein the switch is a change effecting device, and the change effecting device is a memory value, an electronic switch, an electrical switch, a mechanical switch, a fuse, an electromechanical device, a chemical change, an electro-optical filter, an optical emitter, an EM emitter, or a power controller.

27. The wirelessly controlled integrated circuit device according to claim 26, wherein the electronic switch is a FET.

28. The wirelessly controlled integrated circuit device according to claim 26, wherein the power controller is a FET.

29. The wirelessly controlled integrated circuit device according to claim 1, wherein the integrated circuit device and the wireless device are in different package enclosures.

30. A controlled integrated circuit device, comprising:
an integrated circuit having a power-input line;
a wireless communication device, comprising:
a switch connected to the power-input line, the state of the switch set responsive to a received wireless signal;
a circuit power source connected to the switch; and
wherein the state of the switch is set to selectably apply power to the integrated circuit.

31. The controlled integrated circuit device according to claim 30, wherein the wireless communication device is a Radio Frequency (RF) device.

32. The controlled integrated circuit device according to claim 30, wherein the wireless communication device is a Near Field Communication (NFC) device.

33. The controlled integrated circuit device according to claim 30, wherein the switch includes a field effect transistor to control power to the integrated circuit.

34. The controlled integrated circuit device according to claim 30, wherein the wireless device further comprises:
an antenna;
a modulator/demodulator; and
conditional circuitry.

35. The controlled integrated circuit device according to claim 34, wherein the antenna is removable.

36. The controlled integrated circuit device according to claim 34, wherein the conditional circuitry is a logic circuit, a processor, a microprocessor, a microcontroller, or a comparison circuit.

37. The controlled integrated circuit device according to claim 34, wherein the wireless device further includes a power source in the form of a modulator/demodulator or a battery for powering the conditional circuitry.

34. The controlled integrated circuit device according to claim 30, wherein the integrated circuit is a circuit section selected from the group consisting of:
microprocessor, microcontroller, field programmable gate array, memory chip, and memory card.

35. The controlled integrated circuit device according to claim 34, wherein the microprocessor is selected from the group consisting of: Intel Itanium 2, Intel Xeon, Intel Pentium, AMD Opteron, AMD Turion, and AMD Athlon.

36. The controlled integrated circuit device according to claim 34, wherein the field programmable gate array is selected from the group consisting of: Altera Stratix II, Altera Cyclone, Altera MaxII, Silinx Virtex, Xilinx Spartan, Xilinx CoolRunner, Lattice SC, Lattice XP, and Lattice ECP2.

37. The controlled integrated circuit device according to claim 34, wherein the memory card is selected from the group consisting of: PC memory module, SD card, CF card, XD card, USB flash drive, and microdrive.
